(19) United States
(12) Patent Application Publication
(10) Pub. No.: US 2016/0190574 A1
(43) Pub. Date: Jun. 30, 2016

(54) ALKALI METAL TITANIUM OXIDE HAVING ANISOTROPIC STRUCTURE, TITANIUM OXIDE, ELECTRODE ACTIVE MATERIAL CONTAINING SAID OXIDES, AND ELECTRICITY STORAGE DEVICE

(71) Applicants: NATIONAL INSTITUTE OF ADVANCED INDUSTRIAL SCIENCE AND TECHNOLOGY, Tokyo (JP); ISHIHARA SANGYO KAISHA, LTD., Osaka (JP)

(72) Inventors: Hideaki NAGAI, Tsukuba (JP); Junji AKIMOTO, Tsukuba (JP); Kunimitsu KATAOKA, Tsukuba (JP); Yoshimasa KUMASHIRO, Yokkaichi (JP); Tomoyuki SOTOKAWA, Yokkaichi (JP); Nobuharu KOSHIBA, Yokkaichi (JP)

(21) Appl. No.: 14/910,754

(22) PCT Filed: Aug. 14, 2014
(86) PCT No.: PCT/JP2014/071439

§ 371 Date: Feb. 8, 2016

(30) Foreign Application Priority Data
Aug. 19, 2013 (JP) 2013-169623

(51) Int. Cl. H01M 4/485; C01G 23/04; H01M 10/0525; C01G 23/00

(52) U.S. Cl. CPC H01M 4/485; C01G 23/005; C01G 23/04; H01M 10/0525; C01P 2006/12; C01P 2006/40; C01P 2004/50; C01P 2002/70; H01M 2220/30; H01M 2220/20

(57) ABSTRACT

Provided are an alkali metal titanium oxide and titanium oxide that have a novel form and are industrially advantageous. The alkali metal titanium oxide is obtained by firing the result of impregnating the surface and interior of pores of porous titanium compound particles with an aqueous solution of an alkali metal-containing component, and has the form of secondary particles resulting from the aggregation of primary particles having an anisotropic structure. The titanium oxide is obtained using the alkali metal titanium oxide as a starting material. The secondary particles can further assume a clumped structure, have a suitable size, and are easily handled, and so are industrially advantageous. In particular, the H₂Ti₁₂O₂₅ of the present invention is an electrode material that is for a lithium secondary battery, has a high capacity and a superior initial charging/discharging rate and cycling characteristics, and has an extremely high practical value.

### TECHNICAL FIELD

The present invention relates to a secondary particle comprising assembled primary particles with anisotropic structure, and an alkaline metal titanium oxide and a titanium oxide with a novel form of an aggregate made by assembly of these.

The present invention further relates to an electrode active material and a power storage device using these oxides.

### BACKGROUND ART

Currently in Japan, almost all secondary batteries mounted on portable electronic devices such as cell phones and laptop computers are lithium secondary batteries. It is predicted that the lithium secondary batteries will be also put in practical use as large-size batteries for hybrid cars, electric power load leveling systems and the like in the future, and their importance becomes increasingly high.

Any of the lithium secondary batteries has, as major constituents, a positive electrode and a negative electrode capable of reversibly occluding and releasing lithium, and further a separator containing a nonaqueous electrolyte solution, or a solid electrolyte.

Among these constituents, electrode active materials under investigation include oxides such as a lithium cobalt oxide (LiCoO₂), a lithium manganese oxide (LiMn₂O₄) and a lithium titanate (Li₄Ti₅O₁₂), metals such as metallic lithium, lithium alloys and tin alloys, and carbon materials such as graphite and MCMB (mesocarbon microbeads).

The voltage of a battery is determined by difference in the chemical potential depending on the lithium content in each active material. It is a feature of lithium secondary batteries excellent in the energy density that particular combinations of active materials can produce high potential differences.

In particular, the combination of a lithium cobalt oxide LiCoO₂ active material and a carbon material as an electrode is widely used in current lithium batteries, because a voltage of nearly 4 V is possible; the charge and discharge capacity (an amount of lithium extracted from and inserted in the electrode) is large; and the safety is high in addition, this combination of the electrode materials is widely used in current lithium batteries.

On the other hand, it has become clear that a lithium secondary batteries with excellent performance in the charge and discharge cycle over a long period is possible in the combination of a spinel-type lithium manganese oxide (LiMn₂O₄) active material and a spinel-type lithium titanium oxide (Li₄Ti₅O₁₂) active material as electrode, because the materials make the insertion and extraction reaction of lithium to be smoothly carried out and make a change in the crystal lattice volume accompanying the reaction to be smaller, and the combination is put in practical use.

With respect to chemical batteries such as lithium secondary batteries and capacitors, there are demanded electrode active materials of further high performance (large capacity) in combinations of oxide active materials as described above, because it is predicted that there hereafter become necessary large-size and long-life chemical batteries such as power sources for automobiles, large-capacity backup power sources and emergency power sources.

Titanium oxide-based active materials, in the case where a lithium metal is used as a counter electrode, generate a voltage of about 1 to 2 V. Hence, the possibility of titanium oxide-based active materials with various crystal structures is studied as negative electrode active materials.

Among these, there is paid attention, as an electrode material, to a titanium dioxide with sodium bronze-type crystal structure (in the present description, the “titanium dioxide with sodium bronze-type crystal structure” is abbreviated to “TiO₂(B)”), which have properties of smooth insertion and extraction reaction equal to a spinel-type lithium titanium oxide, and higher capacity than the spinel-type. (see Non Patent Literature 1)

For example, a TiO₂(B) active material with nano-scale shape of a nanowire, a nanotube or the like is paid attention to as an electrode material with initial discharge capacity exceeding 300 mAh/g. (see Non Patent Literature 2)

These nano-size materials, however, exhibit a large irreversible capacity since a part of lithium ions intercalated by an initial insertion reaction cannot be extracted, and has an initial charge efficiency (that is, a charge capacity (lithium extraction amount)/a discharge capacity (lithium insertion amount)) of about 73%. Thus there is a problem as a negative electrode material of high-capacity lithium secondary batteries.

Another method can fabricate a TiO₂(B) with μm-size needle-like particle shape (average particle size: several micrometers in length, cross-section: 0.3×0.1 μm) by synthesis using a K₂Ti₄O₉ polycrystal powder fabricated by a high-temperature firing as a starting raw material, and the TiO₂(B) has an initial discharge capacity of about 250 mAh/g, but has a problem with a large irreversible capacity (its initial charge and discharge efficiency is 50%) similar to the nano-size materials. (see Non Patent Literature 3)

Further, a TiO₂(B) with μm-size isotropic shape can be fabricated by using a Na₂Ti₃O₇ powder fabricated by a high-temperature firing as a starting raw material. Although the initial charge and discharge efficiency is as high as 95%, the initial discharge capacity is about 170 mAh/g, which is nearly half of the theoretical capacity (335 mAh/g). Thus higher capacity is needed. (see Patent Literature 1)

Furthermore, the capacity retention rate of the initial cycle (that is, a discharge capacity at the second cycle/a discharge capacity at the first cycle) of TiO₂ (B) as an electrode is as low as 81%, and there is a problem as a negative electrode material in high-capacity lithium secondary batteries. (see Non Patent Literature 4)

As means for solving these problems relevant to the TiO₂(B), there are proposed (1) controlling the crystallite diameter (4 to 50 nm) and the specific surface area (20 to 400 m²/g) of the particle, (2) replacing a part of Ti with Nb or P, (3) modifying TiO₂(B) with various types of cations, and others, but these proposals have a problem of increasing the work processes. (see Patent Literatures 2 to 5)

On the other hand, in a process of fabricating a TiO₂(B) by using Na₂Ti₃O₇ as a starting raw material, H₂Ti₃O₇ made by ion-exchanging Na ions for protons by an acid treatment is subjected to a heat treatment. At this time, in the heat treatment process until the TiO₂(B) is produced, the presence of a metastable phase is reported. (see Non Patent Literature 5)

Furthermore, it is made clear that in a heat treatment process using H₂Ti₃O₇ as a starting raw material, H₂Ti₁₂O₂₅ is present by a heat treatment at 150° C. to lower than 280° C., which is on a lower temperature side than a temperature at which TiO₂(B) is produced.

The H₂Ti₁₂O₂₅ has an isotropic shape, and in the case of being used as an electrode, is capable of making a high capacity of about 230 mAh/g, and has as high an initial charge and discharge efficiency as 90% or higher and as high a capacity retention rate after 10 cycles as 90% or higher. Thus this material is expected as a high-capacity oxide negative electrode material. (Patent Literature 6)

Although H₂Ti₁₂O₂₅ with isotropic shape is disclosed as thus described, no secondary particle thereof with anisotropic shape is disclosed, and also influences of the particle diameter and particle shape of the H₂Ti₁₂O₂₅ on the battery performance are not made clear.

### CITATION LIST

### Patent Literature

Patent Literature 1: JP 2008-117625 A
Patent Literature 2: JP 2010-140863 A
Patent Literature 3: JP 2011-173761 A
Patent Literature 4: JP 2012-166966 A
Patent Literature 5: JP 2011-48947 A
Patent Literature 6: JP 2008-255000 A

### Non Patent Literature

Non Patent Literature 1: L. Brohan, R. Marchand, Solid State Ionics, 9-10, 419-424 (1983)
Non Patent literature 2: A. R. Armstrong, G. Armstrong, J. Canales, R. Garcia, P. G. Bruce, Advanced Materials, 17, 862-865 (2005)
Non Patent literature 3: T. Brousse, R. Marchand, P. L. Taberna, P. Simon, Journal of Power Sources, 158, 571-577 (2006)
Non Patent literature 4: M. Inaba and Y. Oba, F. Niina, Y. Murota, Y. Ogino, A. Tasaka K. Hirota, Journal of Powder Sources, 189, 580-584 (2009)
Non Patent literature 5: T. P. Feist, P. K. Davies, Journal of Solid State Chemistry, 101, 275-295 (1992)

### SUMMARY OF INVENTION

### Technical Problem

The present invention solves the present problems as described above and has an object to provide an alkaline metal titanium oxide and a titanium oxide with novel shape which are important to have excellent in the stability of the charge and discharge cycle over a long period and high capacity as an electrode material for a lithium secondary battery.

### Solution to Problem

As a result of exhaustive studies, the present inventors have found that: when a porous titanium compound particle whose pore interiors and surface are impregnated with an aqueous solution of a component containing alkaline metals such as Li, Na and K is fired, there is produced an alkaline metal titanium oxide with μm-size secondary particle shape made by assembly of primary particles with anisotropic structure such as a needle-like, rod-like or plate-like one; also in a proton exchange product obtained by a reaction of the alkaline metal titanium oxide with an acidic compound, or a titanium oxide obtained by heat treatment of the proton exchange product as a starting raw material, there is held the shape of the μm-size secondary particle made by assembly of the primary particles with anisotropic structure; and further these alkaline metal titanium oxide and titanium oxide with μm-size secondary particle shape made by assembly of the primary particles with anisotropic structure are remarkably excellent as an electrode material. These findings have led to the completion of the present invention.

That is, the present invention provides an alkaline metal titanium oxide and a titanium oxide described below, an electrode active material containing these, and a power storage device using the electrode active material.

(1) An alkaline metal titanium oxide secondary particle comprising assembled primary particles with anisotropic structure.
(2) The alkaline metal titanium oxide secondary particle according to (1), having a composition formula below:

MxTiyOz (1)

wherein M is one or two alkaline metal elements; x/y is 0.06 to 4.05, and z/y is 1.95 to 4.05; in the case where M is two elements, x denotes the total of the two elements.
(3) The alkaline metal titanium oxide secondary particle according to (1), exhibiting an X-ray diffraction pattern of MTiO₂, MTi₂O₄, M₂TiO₃, M₂Ti₃O₇, M₂Ti₄O₉, M₂Ti₅O₁₁, M₂Ti₆O₁₃, M₂Ti₈O₁₇, M₂Ti₁₂O₂₅, M₂Ti₁₈O₃₇, M₄TiO₄ or M₄Ti₅O₁₂, wherein M in the formulae is one or two selected from the group consisting of lithium, sodium, potassium, rubidium and cesium.
(4) The alkaline metal titanium oxide secondary particle according to any one of (1) to (3), forming an aggregate of 0.5 μm or larger and smaller than 500 μm.
(5) The alkaline metal titanium oxide secondary particle according to any one of (1) to (4), having a specific surface area of 0.1 m²/g or larger and smaller than 10 m²/g.
(6) A titanium oxide secondary particle, comprising assembled primary particles with anisotropic structure.
(7) The titanium oxide secondary particle according to (6), having a composition formula below:

HxTiyOz (2)

wherein x/y is 0.06 to 4.05, and z/y is 1.95 to 4.05.
(8) The titanium oxide secondary particle according to (6), exhibiting an X-ray diffraction pattern of HTiO₂, HTi₂O₄, H₂TiO₃, H₂Ti₃O₇, H₂Ti₄O₉, H₂Ti₅O₁₁, H₂Ti₆O₁₃, H₂Ti₈O₁₇, H₂Ti₁₂O₂₅, H₂Ti₁₈O₃₇, H₄TiO₄ or H₄Ti₅O₁₂.
(9) The titanium oxide secondary particle according to (8), exhibiting an X-ray diffraction pattern of H₂Ti₁₂O₂₅.
(10) The titanium oxide secondary particle according to any one of (6) to (9), wherein the secondary particles form an aggregate of 0.5 μm or larger and smaller than 500 μm.
(11) The titanium oxide secondary particle according to any one of (6) to (10), having a specific surface area of 0.1 m²/g or larger and smaller than 10 m²/g.
(12) An electrode active material, comprising an alkaline metal titanium oxide secondary particle or a titanium oxide secondary particle according to any one of (1) to (11).
(13) A power storage device, using an electrode active material according to (12).

### Advantageous Effects of Invention

According to the present invention, there is provided an alkaline metal titanium oxide with μm-size secondary particle shape comprising assembled primary particles with anisotropic structure such as a needle-like, rod-like or plate-like one. Also in a titanium oxide obtained by heat treatment of the alkaline metal titanium oxide, directly or after proton exchange, there is held the shape of the μm-size secondary particle comprising assembled primary particles with anisotropic structure.

By using these alkaline metal titanium oxide and titanium oxide as active materials of an electrode material or a raw material for preparation of an active material, a power storage device with excellent characteristics is enabled to be provided.

The secondary particles according to the present invention can further assemble to form an aggregate and have an aggregate structure, whose particle size can be made a proper one and which is easy to handle. As required, the aggregate structure is easily disintegrated, and is an industrially excellent material.

### BRIEF DESCRIPTION OF DRAWINGS

FIG. 1 is a schematic view showing a production method of an alkaline metal titanium oxide secondary particle comprising assembled primary particles with anisotropic structure according to the present invention.

FIG. 2 is a scanning electron microscope photograph of a porous spherical titanium oxide hydrate obtained in Example 1.

FIG. 3 is a scanning electron microscope photograph of a porous spherical titanium oxide hydrate obtained in Example 1 after impregnation with Na₂CO₃.

FIG. 4 is an X-ray powder diffraction pattern of Na₂Ti₃O₇ (Sample 1) obtained in Example 1.

FIG. 5 is a scanning electron microscope photograph of Na₂Ti₃O₇ (Sample 1) obtained in Example 1.

FIG. 6 is an X-ray powder diffraction pattern of H₂Ti₃O₇ obtained in Example 1.

FIG. 7 is an X-ray powder diffraction pattern of H₂Ti₁₂O₂₅ (Sample 2) obtained in Example 1.

FIG. 8 is a scanning electron microscope photograph of H₂Ti₁₂O₂₅ (Sample 2) obtained in Example 1.

FIG. 9 is a basic structural view of a lithium secondary battery (coin-type cell).

FIG. 10 shows charge and discharge characteristics in the case of using H₂Ti₁₂O₂₅ (Sample 2) obtained in Example 1 as a negative electrode material.

FIG. 11 shows charge and discharge characteristics in the case of using H₂Ti₁₂O₂₅ obtained in Example 2 as a negative electrode material.

FIG. 12 is a scanning electron microscope photograph of a titanium oxide hydrate obtained in Comparative Example 2.

FIG. 13 is an X-ray powder diffraction pattern of Na₂Ti₃O₇ (Sample 3) obtained in Comparative Example 2.

FIG. 14 is a scanning electron microscope photograph of Na₂Ti₃O₇ (Sample 3) obtained in Comparative Example 2.

FIG. 15 is an X-ray powder diffraction pattern of H₂Ti₁₂O₂₅ (Sample 4) obtained in Comparative Example 2.

FIG. 16 shows charge and discharge characteristics in the case of using H₂Ti₁₂O₂₅ (Sample 4) obtained in Comparative Example 2 as a negative electrode material.

### DESCRIPTION OF EMBODIMENTS

(An Alkaline Metal Titanium Oxide)

The present invention relates to an alkaline metal titanium oxide secondary particle and a titanium oxide secondary particle comprising assembled primary particles with anisotropic structure.

Here, the anisotropic structure refers to a needle-like, rod-like, pillar-like, spindle-like, fibrous or another shape, and preferably refers to a shape with aspect ratio (weight-average major-axis diameter/weight-average minor-axis diameter) of preferably 3 or higher, more preferably 5 to 40.

The shape of the primary particle can be checked by an electron microscope; major-axis diameters and minor-axis diameters of at least 100 particles are measured, and on the assumption that all the particles are square pillar-equivalent bodies, values calculated by the following expressions are taken as a weight-average major-axis diameter and a weight-average minor-axis diameter.

A weight-average major-axis diameter=Σ(Ln·Ln·Dn²)/Σ(Ln·Dn²)

A weight-average minor-axis diameter=Σ(Dn·Ln·Dn²)/Σ(Ln·Dn²)

In the above expressions, n represents the number of the individual particles measured; and Ln represents a major-axis diameter of the n-th particle, and Dn represents a minor-axis diameter of the n-th particle.

The weight-average major-axis diameter of the primary particles of the alkaline metal titanium oxide is 0.1 μm to 50 μm, and preferably 0.2 μm to 30 μm; and the weight-average minor-axis diameter thereof is 0.01 μm to 10 μm, and preferably 0.05 μm to 5 μm.

The size of the secondary particle is 0.2 μm or larger and smaller than 100 μm, and more preferably 0.5 μm or larger and smaller than 50 μm; and the specific surface area is 0.1 m²/g or larger and smaller than 10 m²/g. Here, in the present description, the particle size refers to one obtained by measuring particle diameters of 100 particles in an image by a scanning electron microscope or the like and employing the average value (electron microscope method). In the present description, the specific surface area refers to one obtained by a BET method using nitrogen adsorption.

The secondary particles according to the present invention can further assemble and have an aggregate structure, which is an excellent material because of its easy handleability. The size of the aggregate made by further assembly of the secondary particles is 0.5 μm or larger and smaller than 500 μm, and preferably 1 μm or larger and smaller than 200 μm.

The alkaline metal titanium oxide preferably has the following composition formula:

MxTiyOz (1)

wherein M is one or two alkaline metal elements; x/y is 0.06 to 4.05, and z/y is 1.95 to 4.05; in the case where M is two elements, x denotes the total of the two elements.

More specifically, the compounds satisfying the formula (1) include compounds exhibiting X-ray diffraction patterns of MTiO₂, MTi₂O₄, M₂TiO₃, M₂Ti₃O₇, M₂Ti₄O₉, M₂Ti₅O₁₁, M₂Ti₆O₁₃, M₂Ti₈O₁₇, M₂Ti₁₂O₂₅, M₂Ti₁₈O₃₇, M₄TiO₄ and M₄Ti₅O₁₂, wherein M is one or two selected from the group consisting of lithium, sodium, potassium, rubidium and cesium, and the like.

More preferably, the compounds include compounds exhibiting X-ray diffraction patterns of LiTiO₂, LiTi₂O₄, Li₂Ti₆O₁₃, Li₄TiO₄, Li₂TiO₃, Li₂Ti₃O₇, Li₄Ti₅O₁₂ and the like, which are different in the Li/Ti ratio; those of NaTiO₂, NaTi₂O₄, Na₂TiO₃, Na₂Ti₆O₁₃, Na₂Ti₃O₇, Na₄Ti₅O₁₂ and the like, which are different in the Na/Ti ratio; and those of K₂TiO₃, K₂Ti₄O₉, K₂Ti₆O₁₃, K₂Ti₈O₁₇ and the like, which are different in the K/Ti ratio.

In the present description, alkaline metal titanium oxides exhibiting X-ray diffraction patterns of MTiO₂ or the like include not only ones with stoichiometric compositions of MTiO₂ or like; but even ones whose some elements are defective or excessive and which have nonstoichiometric compositions are included in that scope as long as the ones exhibit X-ray diffraction patterns characteristic of compounds of MTiO₂ or the like.

For example, a lithium titanium compound exhibiting an X-ray diffraction pattern of Li₄Ti₅O₁₂ includes, in addition to Li₄Ti₅O₁₂ of a stoichiometric composition, lithium titanium compounds which do not have a stoichiometric composition of Li₄Ti₅O₁₂, but exhibit peaks characteristic to Li₄Ti₅O₁₂ at positions of 2θ of 18.5°, 35.7°, 43.3°, 47.4°, 57.3°, 62.9° and 66.1° (an error in any of which is about ±0.5°) in a powder X-ray diffractometry (using a CuKα line). Further, for example, a sodium titanium compound exhibiting an X-ray diffraction pattern of Na₂Ti₃O₇ includes, in addition to Na₂Ti₃O₇ of a stoichiometric composition, sodium titanium compounds which do not have a stoichiometric composition of Na₂Ti₃O₇, but exhibit peaks characteristic to Na₂Ti₃O₇ at positions of 2θ of 10.5°, 15.8°, 25.7°, 28.4°, 29.9°, 31.9°, 34.2°, 43.9°, 47.8°, 50.2° and 66.9° (an error in any of which is about ±0.5°) in a powder X-ray diffractometry (using a CuKα line).

Further, alkaline metal titanium oxides with peaks originated from other crystal structures, that is, having sub phases, in addition to a main phase, are included in the scope of the present invention. In the case of inclusion of sub phases, with the integrated intensity of a main peak of the main phase being taken to be 100, the integrated intensity of a main peak attributed to the sub phases is preferably 30 or lower, and more preferably 10 or lower, and still more preferably, the alkaline metal titanium oxide is a single phase containing no sub phase.

### (Titanium Oxide)

The present invention relates also to a titanium oxide secondary particle comprising assembled primary particles with anisotropic structure. In the present description, the titanium oxide refers to a compound composed of Ti and H and O.

The definition of anisotropic structure, and the aspect ratio, and the weight-average major axis diameter and the weight-average minor-axis diameter of the primary particles, the size and the specific surface area of the secondary particle, the point that the secondary particles can have an aggregate structure, and the size of the aggregate structure, are the same as in the alkaline metal titanium oxide.

The titanium oxide preferably has the following composition formula:

HxTiyOz (2)

wherein x/y is 0.06 to 4.05, and z/y is 1.95 to 4.05.

Specifically, compounds satisfying the formula (2) include titanium oxides exhibiting X-ray diffraction patterns of HTiO₂, HTi₂O₄, H₂TiO₃, H₂Ti₃O₇, H₂Ti₄O₉, H₂Ti₅O₁₁, H₂Ti₆O₁₃, H₂Ti₈O₁₇, H₂Ti₁₂O₂₅, H₂Ti₁₈O₃₇, H₄TiO₄ and H₄Ti₅O₁₂.

Among these, most preferable are compounds exhibiting peaks characteristic to H₂Ti₁₂O₂₅ at positions of 2θ in X-ray diffraction patterns of 14.0°, 24.6°, 28.5°, 29.5°, 43.3°, 44.4°, 48.4°, 52.7° and 57.8° (an error in any of which is about ±0.5°) in a powder X-ray diffractometry (using a CuKα line).

The titanium oxide according to the present invention can have a shape of an aggregate made by further assembly of secondary particles comprising assembled primary particles.

The secondary particles according to the present invention are ones which are in the state that the primary particles firmly bond with one another, and are not secondary particles assembled by interparticle interactions such as the van der Waals force or made by mechanical compaction but secondary particles which are not easily disassembled by usual industrial operations such as mixing, disintegration, filtration, water washing, transportation, weighing, bagging and piling and which almost all remain as the secondary particles even after these operations. The primary particle has an anisotropic shape, but the shape of the secondary particle to be used is not especially limited, and can assume various shapes.

By contrast, the aggregate, unlike the secondary particle, is disassembled by the above-mentioned industrial operations. The shape, similarly to the secondary particle, is not especially limited, and the aggregates with various shapes can be used.

On the surface of the primary particle, the secondary particle or the aggregate, there can be coated at least one selected from the group consisting of inorganic compounds such as carbon, silica and alumina, and organic compounds such as a surfactant and a coupling agent. In the case of using two or more thereof, the coating may be carried out by laminating one layer of every one of the two or more thereof or as a mixture or a composite material of the two or more thereof. The kind of the coating is suitably selected according to the purpose, and particularly in the case of the use as an electrode active material, coating of carbon is preferable because the electroconductivity is improved. The coating amount of carbon is preferably in the range of 0.05 to 10% by weight in terms of C with respect to the titanium oxide according to the present invention in terms of TiO₂. When the amount is smaller than this range, a desired electroconductivity cannot be obtained; and when being larger, the characteristics decrease on the contrary. A more preferable coating amount is in the range of 0.1 to 5% by weight. Here, the coating amount of carbon can be analyzed by a CHN analysis method, a high-frequency combustion method or the like. Dissimilar elements other than titanium can further be contained by doping or otherwise in the crystal lattice in the range of not inhibiting the above-mentioned crystal structure.

The alkaline metal titanium oxide and the titanium oxide according to the present invention can be produced by the following methods.

### (A Production Method of the Alkaline Metal Titanium Oxide)

The pore interiors and surface of a porous titanium compound particle is impregnated with an alkaline metal-containing component, and the obtained product is fired to thereby produce the alkaline metal titanium oxide.

### (1) The Porous Titanium Compound Particle

The porous titanium compound as a raw material includes porous titanium and titanium compounds, and at least one thereof is used.

The titanium compounds are not especially limited as long as containing titanium, and examples thereof include oxides such as TiO, Ti₂O₃ and TiO₂, titanium oxide hydrates represented by TiO(OH)₂, TiO₂.xH₂O (x is arbitrary), and besides water-insoluble inorganic titanium compounds. Among these, titanium oxide hydrates are especially preferable, and there can be used metatitanic acid represented by TiO(OH)₂ or TiO₂—H₂O, orthotitanic acid represented by TiO₂.2H₂O, and mixtures thereof.

A titanium oxide hydrate can be obtained by thermal hydrolysis or neutralizing hydrolysis of a titanium compound. For example, metatitanic acid can be obtained by thermal hydrolysis, neutralizing hydrolysis or the like of titanyl sulfate (TiOSO₄), or neutralizing hydrolysis at a high temperature or the like of titanium chloride; orthotitanic acid, by neutralizing hydrolysis at a low temperature of titanium sulfate (Ti(SO₄)₂) or titanium chloride; and a mixture of metatitanic acid and orthotitanic acid, by suitable control of the neutralizing hydrolysis temperature of titanium chloride. A neutralizing agent to be used in the neutralizing hydrolysis is not especially limited as long as being a usual water-soluble alkaline compound, and there can be used sodium hydroxide, potassium hydroxide, calcium hydroxide, sodium carbonate, potassium carbonate, ammonia and the like. There can further be used urea ((NH₂)₂CO+H₂O→2NH₃+CO₂) or the like to produce an alkaline compound by an operation such as heating.

The specific surface area to be a factor indicating the porosity of the titanium oxide hydrate thus obtained can be controlled by the deposition speed of the precipitation of the titanium oxide hydrate, or controlled by aging the produced titanium oxide hydrate in an aqueous solution. For example, by controlling the thermal hydrolysis temperature, or controlling the concentration and the dropping speed of the neutralizing agent for the neutralizing hydrolysis, the deposition speed of the precipitation of the titanium oxide hydrate can be controlled. When the produced titanium oxide hydrate is held in the state of being stirred in a high-temperature aqueous solution, the dissolution-redeposition of the titanium oxide hydrate in the aqueous solution is caused by Ostwald ripening, and the particle diameter increases and the pore is clogged to reduce the specific surface area; thereby this treatment can also regulate the porosity.

The particle shape of the porous titanium compound is not especially limited, including isotropic shapes such as spherical and polyhedral ones, and anisotropic shapes such as rod-like and plate-like ones.

The particle size of the porous titanium compound is determined by measuring particle diameters of 100 particles in an image by a scanning electron microscope or the like and employing its average value (electron microscope method). The particle size is not especially limited, but has a correlation with the size of the produced alkaline metal titanium oxide or titanium oxide. Hence, for example, in the case of using the alkaline metal titanium oxide or the titanium oxide as an electrode active material, the porous titanium compound is an isotropic and preferably spherical primary particle; and the particle size is preferably 0.1 μm or larger and smaller than 100 μm, and more preferably 0.5 μm or larger and smaller than 50 μm.

The specific surface area (by the BET method using nitrogen adsorption) of the porous titanium compound is preferably 10 m²/g or larger and smaller than 400 m²/g, and more preferably 50 m²/g or larger and smaller than 300 m²/g.

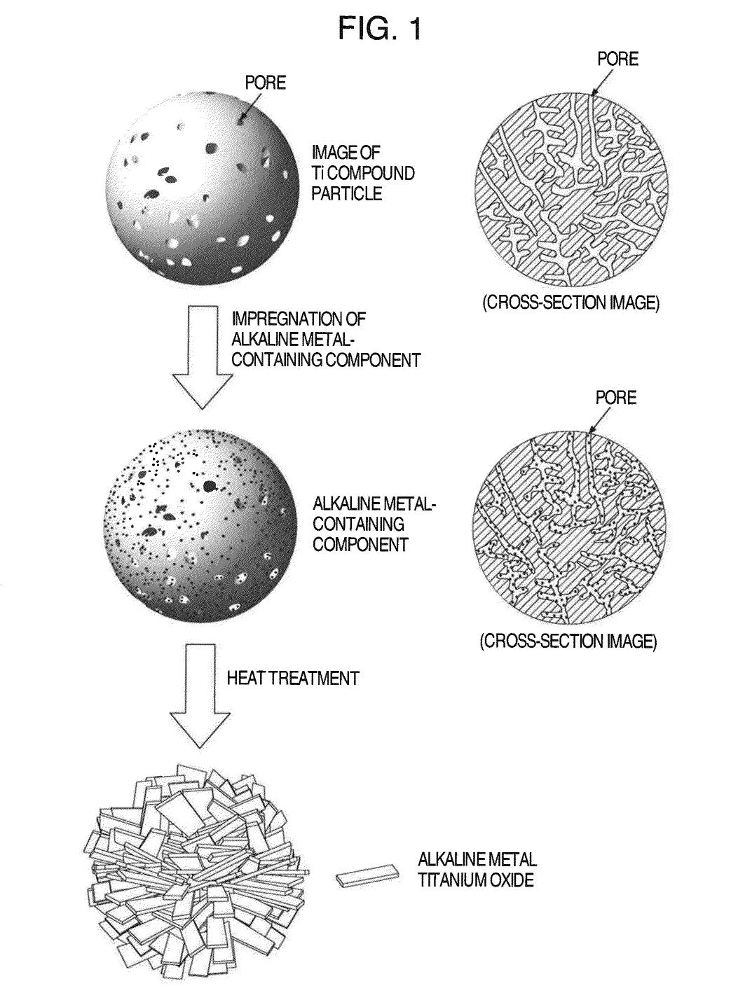

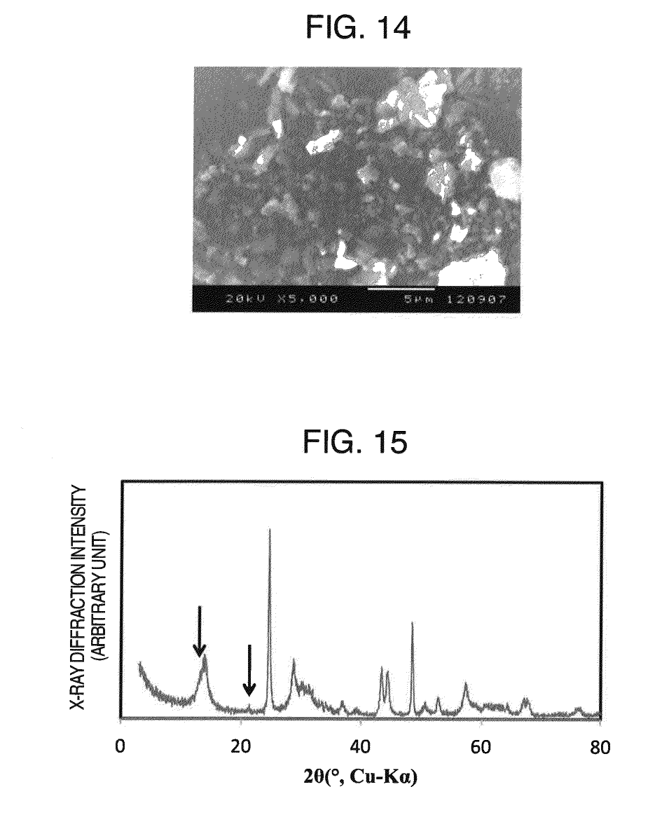

When the specific surface area of the porous titanium compound is too large, the reactivity between the titanium compound and an alkaline metal compound becomes too high; the growth of the particle of an alkaline metal titanium oxide being reaction product too much progresses; then there cannot be obtained the shape according to the present application which is a secondary particle comprising assembled primary particles with anisotropic structure. For example, when there is used a primary particle of the titanium compound whose specific surface area is 10 m²/g or larger and smaller than 400 m²/g, a secondary particle of an alkaline metal titanium oxide with anisotropic structure can be produced (see Example 1, and FIG. 1 and FIG. 5). By contrast, when there is used a primary particle of the titanium compound whose specific surface area is 400 m²/g or larger, a primary particle of an alkaline metal titanium oxide with isotropic structure is formed due to the particle growth (see Comparative Example 2, and FIG. 14).

Further, the average pore diameter is preferably between 3.4 nm and 10 nm; and the pore volume is preferably between 0.05 cm³/g and 0.35 cm³/g.

The pore volume can be determined by determining a pore distribution by analyzing a nitrogen adsorption and desorption isotherm determined by the nitrogen adsorption method with the BET method, the HK method, the BJH method or the like, and calculating a pore volume from the pore distribution. The average pore diameter can be determined from the measurement values of the total pore volume and the specific surface area.

### (2) An Alkaline Metal-Containing Component

An alkaline metal-containing component is not especially limited as long as being a compound containing an alkaline metal (alkaline metal compound) and being soluble in water. For example, in the case where the alkaline metal is Li, the alkaline metal compound includes salts such as Li₂CO₃ and LiNO₃, hydroxides such as LiOH, and oxides such as Li₂O. In the case where the alkaline metal is Na, the alkaline metal compound includes salts such as Na₂CO₃ and NaNO₃, hydroxides such as NaOH, and oxides such as Na₂O and Na₂O₂. In the case where the alkaline metal is K, the alkaline metal compound includes salts such as K₂CO₃ and KNO₃, hydroxides such as KOH, and oxides such as K₂O and K₂O₂. In the case of production of a sodium titanium oxide, Na₂CO₃ and the like are especially preferable.

(3) Impregnation of the Porous Titanium Compound Particle with the Alkaline Metal-Containing Component, and Firing

The dried porous titanium compound particle is impregnated with an aqueous solution containing one or two of the above-mentioned alkali metal compounds selected from lithium, sodium, potassium, rubidium, cesium and the like so as to make a target chemical composition, filtered, thereafter as required, dried, and heated in an atmosphere where oxygen gas is present, such as in air, or in an inert gas atmosphere such as nitrogen or argon to thereby produce the alkaline metal titanium oxide.

FIG. 1 schematically shows the situation in which the impregnation of the porous titanium compound particle with the alkaline metal-containing component, and firing the resultant synthesize the alkaline metal titanium oxide.

FIG. 1 schematically shows that a secondary particle of the alkaline metal titanium oxide with anisotropic structure is produced from primary particles of the isotropic titanium compound.

### A Preparatory Step of Impregnation

As described above, the surface and pores of the porous titanium compound is impregnated with the alkaline metal-containing component so as to make a target chemical compound. The impregnation amount of an aqueous solution of the alkali metal compound in the porous titanium compound, since changing by the surface area and the pore volume of the porous titanium compound as a raw material, needs to be confirmed previously.

Specifically, the porous titanium compound is dried to remove moisture in the pores, and suspended in an aqueous solution to fully swell the pore interiors and the surface of the titanium compound with the aqueous solution in which the alkali metal compound is dissolved. Then, a solid fraction and a solution fraction are separated by filter filtration, centrifugation or the like, and the saturation amount (maximum impregnation amount) of the aqueous solution impregnated in the porous titanium compound is measured. Since the titanium compound has the hydrophilic surface, when the titanium compound particle is immersed in the aqueous solution in which the alkali metal compound is dissolved, the aqueous solution can be filled up to pore depths of the titanium compound particle and impregnated in a short time.

Since the saturation amount itself does not vary depending on the concentration of the alkali metal compound, the amount of the alkali metal compound to be impregnated can be regulated by changing the concentration. In the case where the impregnation amount of the alkali metal compound is insufficient by a one-time impregnation step, the impregnation amount of the alkali metal compound is increased by repeating the step and a target chemical composition is enabled to be made.

A Regular Step of Impregnation

The porous titanium compound is dried to remove moisture in the pores, and suspended in an aqueous solution in which the alkali metal compound regulated to the predetermined concentration confirmed in the preparatory step is dissolved, to fully swell the pore interiors and the surface of the titanium compound with the aqueous solution in which the alkali metal compound such as Li, Na, K or the like is dissolved. After the alkali metal compound is impregnated up to the depths of the porous titanium compound so as to make a desired chemical composition, a solid fraction and a solution fraction are separated by filter filtration, a centrifuge or the like, and the solid fraction is preferably dried. In the case where the impregnation amount of the alkali metal compound of Li, Na, K or the like is insufficient by a one-time impregnation step, the impregnation amount of the alkali metal compound is increased by repeating the step and a target chemical composition is made.

Here, the target chemical composition suffices if being capable of providing a compound exhibiting an X-ray diffraction pattern similar to that characteristic of a desired alkaline metal titanium oxide.

The concentration of the alkali metal compound can be varied preferably between 0.1 time and 1.0 time the saturation concentration; and the impregnation time is usually between 1 min and 60 min, and preferably between 3 min and 30 min.

Firing

Then, the titanium compound particle impregnated with the alkali metal compound is fired.

The firing temperature can suitably be set depending on the kinds of the raw materials, and may be set usually at about 600° C. to 1,200° C., and preferably at 700° C. to 1,050° C. Further, the firing atmosphere is not especially limited, and the firing may be carried out usually in an oxygen gas atmosphere such as in air, or in an inert gas atmosphere such as nitrogen or argon.

The firing time can suitably be altered according to the firing temperature and the like. The cooling method also is not especially limited, and may usually be spontaneous cooling (in-furnace spontaneous cooling) or gradual cooling.

After the firing, as required, the fired material is crushed by a well-known method, and the above firing process may be again carried out. Here, the degree of the crushing may suitably be regulated according to the firing temperature and the like.

### (A Production Method of a Proton Exchange Product of the Alkaline Metal Titanium Oxide)

By using the alkaline metal titanium oxide obtained in the above as a starting raw material, and by applying a proton exchange reaction in an acidic aqueous solution, there is obtained a proton exchange product of the alkaline metal titanium oxide in which almost all of the alkaline metal in the starting raw material compound is exchanged for hydrogen.

In this case, it is preferable that the alkaline metal titanium oxide obtained in the above is dispersed in an acidic aqueous solution and held for a certain time, and thereafter dried. As an acid to be used, preferable is an aqueous solution containing one or more of hydrochloric acid, sulfuric acid, nitric acid and the like in any concentration. Use of dilute hydrochloric acid of 0.1 to 1.0 N in concentration is preferable. The treatment time is 10 hours to 10 days, and preferably 1 day to 7 days. In order to shorten the treatment time, it is preferable that the solution is suitably replaced by a fresh one. Further, in order to make the exchange reaction to easily progress, it is preferable that the treatment temperature is made to be higher than room temperature (20° C.), and to be 30° C. to 100° C. The drying can be applied to by a well-known drying method, and vacuum drying or the like is more preferable.

In the proton exchange product of the alkaline metal titanium oxide thus obtained, the residual alkaline metal amount originated from the starting material can be reduced below the detection limit of the chemical analysis with a wet method by optimizing the exchange treatment condition.

(A Heat Treatment of the Proton Exchange Product of the Alkaline Metal Titanium Oxide, that is, a Production Method of a Titanium Oxide)

The proton exchange product of the alkaline metal titanium oxide thus obtained is used as a starting raw material, and is subjected to a heat treatment in an oxygen gas atmosphere such as in air, or in an inert gas atmosphere such as nitrogen or argon, to thereby obtain a titanium oxide.

For example, in the case where H₂Ti₁₂O₂₅ as the titanium oxide is synthesized by using H₂Ti₃O₇ as the proton exchange product, the target titanium oxide H₂Ti₁₂O₂₅ is obtained accompanied by the generation of H₂O due to thermal decomposition. In this case, the heat treatment temperature is in the range of 250° C. to 350° C., preferably in the range of 270° C. to 330° C. The treatment time is usually 0.5 to 100 hours, and preferably 1 to 30 hours; and the higher the treatment temperature, the shorter the treatment time can be.

### (An Electrode Active Material)

The alkaline metal titanium oxide and the titanium oxide with anisotropic structure according to the present invention are excellent in any of the initial discharge capacity, the initial charge and discharge efficiency and the capacity retention rate at the initial cycle. Therefore, a power storage device using as a constituent member an electrode containing such oxides as an electrode active material has a high capacity and is capable of the reversible insertion and extraction reactions of ions such as lithium ions, and the power storage device is one whose high reliability can be expected.

### (The Power Storage Device)

The power storage device according to the present invention specifically includes lithium secondary batteries, sodium secondary batteries, magnesium secondary batteries, calcium secondary batteries, and capacitors; and these are constituted of an electrode containing as an electrode active material the alkaline metal titanium oxide or the titanium oxide according to the present invention, a counter electrode, a separator, and an electrolyte solution.

That is, battery elements of well-known lithium secondary batteries, sodium secondary batteries, magnesium secondary batteries, calcium secondary batteries and capacitors (coin-type, button-type, cylindrical type, laminate-type, wholly solid-type and the like) can be employed as they are, except for using the alkaline metal titanium oxide or the titanium oxide according to the present invention as the electrode active material. FIG. 9 is a schematic view showing one example of coin-type lithium secondary battery to which a lithium secondary battery as one example of the power storage device according to the present invention is applied. The coin-type battery 1 is constituted of a negative electrode terminal 2, a negative electrode 3, (a separator+an electrolyte solution) 4, an insulating packing 5, a positive electrode 6, and a positive electrode can 7.

In the present invention, the active material containing the alkaline metal titanium oxide or the titanium oxide according to the present invention is blended, as required, with an electroconductive agent, a binder and the like to thereby prepare an electrode mixture, and the electrode mixture is pressure-bonded on a current collector to thereby fabricate an electrode. As the current collector, there can be used preferably a copper mesh, a stainless steel mesh, an aluminum mesh, a copper foil, an aluminum foil or the like. As the electroconductive agent, acetylene black, Ketjen black or the like is preferably used. As the binder, polytetrafluoroethylene, polyvinylidene fluoride or the like is preferably used.

The blending of the active material containing the alkaline metal titanium oxide or the titanium oxide, the electroconductive agent, the binder and the like in the electrode mixture is not especially limited; but it usually suffices if the electroconductive agent is about 1 to 30% by weight (preferably 5 to 25% by weight); the binder is 0 to 30% by weight (preferably 3 to 10% by weight); and the remainder is the alkaline metal titanium oxide or the titanium oxide according to the present invention.

In a lithium secondary battery in the power storage devices according to the present invention, as a counter electrode to the above electrode, there can be employed a well-known one which functions as a positive electrode and is capable of occluding and releasing lithium, including, for example, a lithium transition metal composite oxide such as a lithium manganese composite oxide, a lithium cobalt composite oxide, a lithium nickel composite oxide or a lithium vanadium composite oxide, or an olivine-type compound such as a lithium iron phosphate compound.

Further, in a lithium secondary battery in the power storage devices according to the present invention, as a counter electrode to the above electrode, there can be employed a well-known one which functions as a negative electrode and is capable of occluding and releasing lithium, including, for example, metallic lithium, a lithium alloy or a carbon material such as graphite or MCMB (mesocarbon microbeads).

In a sodium secondary battery in the power storage devices according to the present invention, as a counter electrode to the above electrode, there can be employed a well-known one which functions as a positive electrode and is capable of occluding and releasing sodium, including, for example, a sodium transition metal composite oxide such as a sodium iron composite oxide, a sodium chromium composite oxide, a sodium manganese composite oxide or a sodium nickel composite oxide.

Further, in a sodium secondary battery in the power storage devices according to the present invention, as a counter electrode to the above electrode, there can be employed a well-known one which functions as a negative electrode and is capable of occluding and releasing sodium, including, for example, metallic sodium, a sodium alloy or a carbon material such as graphite.

In a magnesium secondary battery or a calcium secondary battery in the power storage devices according to the present invention, as a counter electrode to the above electrode, there can be employed a well-known one which functions as a positive electrode and is capable of occluding and releasing magnesium or calcium, including, for example, a magnesium transition metal composite oxide or a calcium transition metal composite oxide.

Further, in a magnesium secondary battery or a calcium secondary battery in the power storage devices according to the present invention, as a counter electrode to the above electrode, there can be employed a well-known one which functions as a negative electrode and is capable of occluding and releasing magnesium or calcium, including, for example, metallic magnesium, a magnesium alloy, metallic calcium, a calcium alloy or a carbon material such as graphite.

A capacitor in the power storage devices according to the present invention can be an asymmetrical capacitor using a carbon material such as graphite as a counter electrode to the above electrode.

In the power storage device according to the present invention, a separator, a battery container and the like may employ well-known battery elements.

Further, as an electrolyte, a well-known electrolyte solution, solid electrolyte or the like can be applied. There can be used as the electrolyte solution, for example, in which a lithium salt such as LiPF₆, LiClO₄, LiCF₃SO₃, LiN(CF₃SO₂)₂ or LiBF₄ is dissolved in a solvent such as ethylene carbonate (EC), dimethyl carbonate (DMC), propylene carbonate (PC), diethyl carbonate (DEC) or 1,2-dimethoxyethane.

### EXAMPLES

Hereinafter, Examples will be shown and much more clarify features of the present invention. The present invention is not limited to these Examples.

### Example 1

### Production Method of Na₂Ti₃O₇

6.25 g of titanyl sulfate hydrate ((TiOSO₄.xH₂O, x is 2 to 5) was added and dissolved in 200 ml of a sulfuric acid aqueous solution containing 7 ml of 95% sulfuric acid, and distilled water was added to finally make 250 ml of a solution. The solution was put in a round-bottom three-necked flask, and heated in an oil bath at 85° C. under stirring by a stirring propeller. The solution caused white turbidity by the self-hydrolysis of titanyl sulfate. The three-necked flask was taken out from the oil bath at 1.5 hours after the start of the heating, and cooled by flowing water. An obtained white-turbid solid material was separated by a centrifugal separator, three times repeatedly washed with distilled water, and dried at 60° C. for one day and night to thereby make a titanium raw material for production of Na₂Ti₃O₇.

It was found that the obtained titanium raw material was an amorphous titanium oxide with broad peaks at the peak position of anatase-type TiO₂ in X-ray powder diffractometry. Further, a clear weight loss and endothermic reaction accompanying dehydration were observed at nearly 100° C. by thermogravimetry, revealing that the titanium raw material was a titanium oxide hydrate. It was further found that the titanium raw material was powder, and a porous body which had a specific surface area of 153 m²/g as measured by the BET specific surface area measurement, an average pore diameter of 3.7 nm, and a pore volume of 0.142 cm³/g. It further became clear by the scanning electron microscope (SEM) observation that spherical particles of 1 to 5 μm aggregated (FIG. 2).

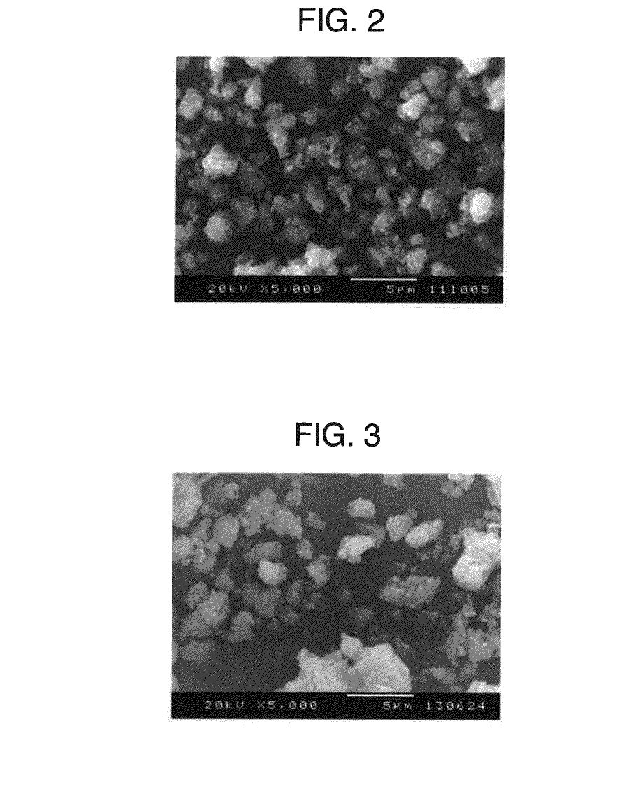

About 1 g of the porous titanium oxide hydrate was suspended in 100 ml of a Na₂CO₃ aqueous solution of 216 g/l, and ultrasonically dispersed for 5 min to thereby fully swell the pore interiors and the surface with the Na₂CO₃ aqueous solution, thereafter separated from the aqueous solution by filter filtration, and dried at 60° C. for one day and night. The impregnation amount of the porous titanium oxide hydrate with the Na₂CO₃ aqueous solution was previously measured; and the concentration of the Na₂CO₃ aqueous solution was made to be one to make a chemical composition of Na₂Ti₃O₇. The scanning electron microscope (SEM) observed that the state of the aggregation of spherical particles of 1 to 5 μm was the same as that of the titanium oxide hydrate used as the raw material, and observed no situation of the deposition of crystals of the impregnated Na₂CO₃ (FIG. 3). Further, according to an analysis using an energy dispersive X-ray spectrometer, it became clear that since a Na element and a Ti element were both present in individual particles, almost all Na₂CO₃ was present in pores inside the particle, or was present in a microparticle state on the particle surface. This was packed in an alumina-made boat, and heated in air at a high temperature by using an electric furnace. The firing temperature was made to be 800° C., and the firing time was made to be 10 hours. Thereafter, the resultant was spontaneously cooled in the electric furnace to thereby obtain Sample 1.

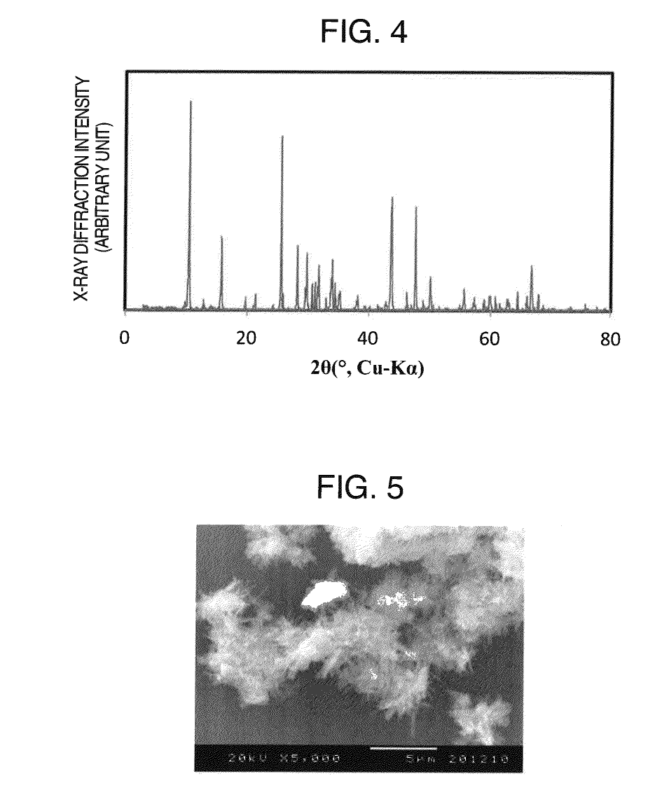

It became clear that Sample 1 thus obtained was a single phase of Na₂Ti₃O₇ with good crystallinity by X-ray powder diffractometry (FIG. 4). A scanning electron microscope (SEM) observation clarified that needle-like particles of 0.1 to 0.4 μm in diameter and 1 to 5 μm in length aggregated like chestnut spikes to make secondary particles of 2 to 10 μm, which further aggregated to thereby form an aggregate (FIG. 5).

The weight-average major-axis diameter of the primary particles was 2.45 μm; the weight-average minor-axis diameter thereof was 0.47 μm; and the aspect ratio thereof was 5.2 (the number of the particles measured: 100).

It became clear that spherical primary particles of 1 to 5 μm of the porous titanium oxide hydrate formed a large number of Na₂Ti₃O₇ particles in needle-like forms by a reaction with Na₂CO₃ impregnated in the pore interiors and the surface of the primary particles, and the needle-like particles assembled to thereby form secondary particles. Further, a BET specific surface area measurement clarified that the specific surface area of this powder was 1.8 m²/g, and the particles were solid particles with few pores.

The minimum value of the measurement of the aggregated particles was 1.4 μm; the maximum value thereof was 35.7 μm; and the average particle size was 9.9 μm. Here, the assembly had almost no influence on the specific surface area.

(Production Method of a Proton Exchange Product H₂Ti₃O₇)

Na₂Ti₃O₇ (Sample 1) obtained in the above was used as a starting raw material, immersed in a 0.5 N hydrochloric acid aqueous solution, and held under the condition of 60° C. for 3 days to thereby carry out a proton exchange treatment. In order to raise the exchange treatment speed, the hydrochloric acid aqueous solution was replaced at every 24 hours. The use amount of the hydrochloric acid aqueous solution per one time was made to be 200 ml with respect to 0.75 g of the Na₂Ti₃O₇ sample. Thereafter, the sample was washed with water, and dried at 60° C. for one day and night to thereby obtain a target proton exchange product.

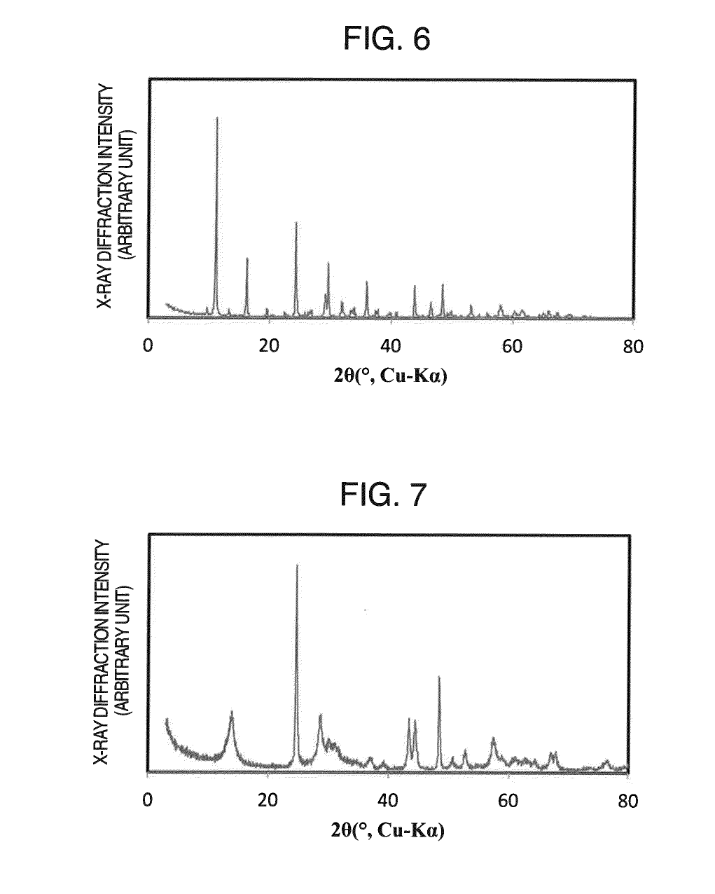

It became clear that the proton exchange product thus obtained was a single phase of H₂Ti₃O₇ by X-ray powder diffractometry (FIG. 6). Further, a scanning electron microscope (SEM) observation clarified that the proton exchange product was one holding the shape of Na₂Ti₃O₇ as the starting raw material, and aggregates of secondary particles formed by assembly of needle-form H₂Ti₃O₇ particles.

(Production Method of a Titanium Oxide H₂Ti₁₂O₂₅)

Then, the H₂Ti₃O₇ obtained in the above was packed in an alumina crucible, thereafter subjected to a heat treatment in air at 280° C. for 5 hours to thereby obtain Sample 2.

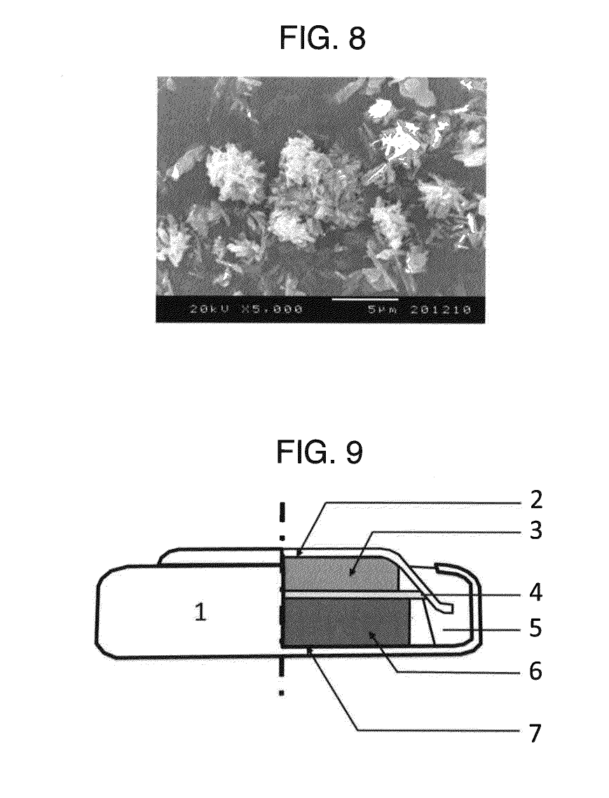

It became clear that Sample 2 thus obtained exhibited a diffraction pattern characteristic of H₂Ti₁₂O₂₅ as seen in a past report in X-ray powder diffractometry (FIG. 7). Further, a scanning electron microscope (SEM) observation clarified that Sample 2 was an aggregate of secondary particles which held the shape of Na₂Ti₃O₇ as the starting raw material and the proton exchange product H₂Ti₃O₇, and was made by aggregation of secondary particles made by aggregation of the needle-form H₂Ti₁₂O₂₅ particles (FIG. 8).

The weight-average major axis diameter of the needle-like primary particles was 2.30 μm; the weight-average minor-axis diameter thereof was 0.46 μm and the aspect ratio thereof was 5.0 (the number of particles measured: 100). The minimum value of the measurement of the aggregated particles was 1.4 μm; the maximum value thereof was 20.7 μm; and the average particle size was 7.2 μm.

### (A Lithium Secondary Battery)

A lithium secondary battery (coin-type cell) as shown in FIG. 9 was fabricated, in which an electrode was fabricated by using H₂Ti₁₂O₂₅ (Sample 2) thus obtained as an active material, acetylene black as an electroconductive agent and polytetrafluoroethylene as a binder blended in 5:5:1 in weight ratio; using a lithium metal as a counter electrode; and using as an electrolyte solution a 1 M solution of lithium hexafluorophosphate dissolved in a mixed solvent (1:1 in volume ratio) of ethylene carbonate (EC) and diethyl carbonate (DEC). Then, its electrochemical lithium insertion and extraction behavior was measured. The fabrication of the battery was carried out according to the structure and the assembling method of well-known cells.

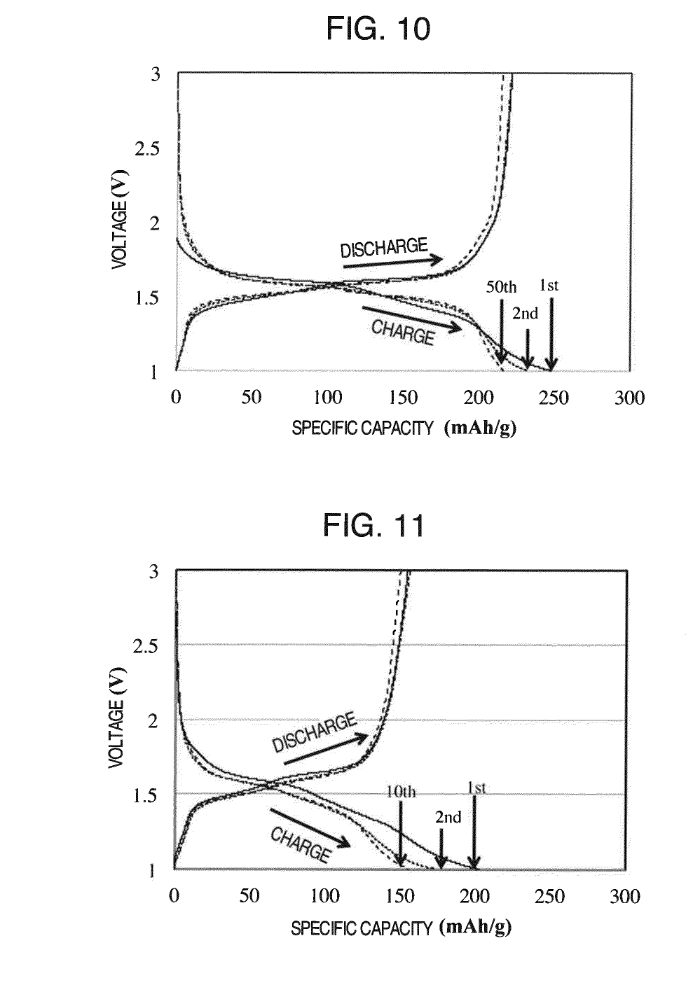

For the fabricated lithium secondary battery, there was carried out an electrochemical lithium insertion and extraction test under the temperature condition of 25° C. at a current density of 10 mA/g at cutoff potentials of 3.0 V-1.0 V; then, it was found that a voltage plateau was at nearly 1.6 V, and the reversible lithium insertion and extraction reaction was possible. The voltage variation accompanying the insertion and extraction of lithium is shown in FIG. 10. The lithium insertion amount of Sample 2 was equivalent to 9.04 per chemical formula of H₂Ti₁₂O₂₅, and the initial insertion amount per active material weight was 248 mAh/g, which was nearly the same as that of the TiO₂(B), and was a larger amount than 236 mAh/g of an isotropic shape H₂Ti₁₂O₂₅. The initial charge and discharge efficiency of Sample 2 was 89%, which was higher than 50% of the TiO₂(B), and was nearly equal to that of the isotropic shape H₂Ti₁₂O₂₅. Further, the capacity retention rate at the initial cycle of Sample 2 was 94%, which was higher than 81% of the TiO₂(B), and was nearly equal to that of the isotropic shape H₂Ti₁₂O₂₅. It became clear that also after 50 cycles, the discharge capacity of 216 mAh/g could be maintained. From the above, it became clear that the H₂Ti₁₂O₂₅ active material with anisotropic structure according to the present invention has a high capacity nearly equal to that of the TiO₂(B) and makes possible a lithium insertion and extraction reaction high in the reversibility nearly equal to that of the isotropic shape H₂Ti₁₂O₂₅, and is promising as a lithium secondary battery electrode material.

### Comparative Example 1

1 g of a commercially available TiO₂ (manufactured by Kojundo Chemical Laboratory Co., Ltd., rutile-type, average particle diameter: 2 μm, specific surface area: 2.8 m²/g) was suspended in 100 ml of a Na₂CO₃ aqueous solution of 216 g/l, and ultrasonically dispersed for 5 min; then, the sample was separated from the aqueous solution by filter filtration. Thereafter, the sample was dried at 60° C. for one day and night. The sample was packed in an alumina-made boat, and heated in air at a high temperature by using an electric furnace. The firing temperature was made to be 800° C., and the firing time was made to be 10 hours. Thereafter, the sample was spontaneously cooled in the electric furnace. The obtained sample contained a rutile-type TiO₂ as a main component, and a partially produced Na₂Ti₆O₁₃ by an X-ray powder diffractometry. From this, it was found that the obtained sample contained no Na₂Ti₃O₇.

### Example 2

The precursor H₂Ti₃O₇ synthesized in Example 1 was subjected to a heat treatment for 50 hours at 240° C., which was lower than 280° C. of the heat treatment temperature of the synthesis condition of H₂Ti₁₂O₂₅ of Example 1. An X-ray powder diffractometry of the obtained sample exhibited peaks other than the diffraction pattern characteristic of H₂Ti₁₂O₂₅ as seen in a past report; from this, the obtained sample was not a single phase of H₂Ti₁₂O₂₅, but maintained a shape of a secondary particle comprising assembled primary particles with anisotropic structure.

(A Lithium Secondary Battery)

An electrode was fabricated by using the sample thus obtained as an active material, acetylene black as an electroconductive agent and polytetrafluoroethylene as a binder blended in 5:5:1 in weight ratio. A lithium secondary battery (coin-type cell) as shown in FIG. 9 was fabricated by using the electrode, using a lithium metal as a counter electrode, and using as an electrolyte solution a 1 M solution of lithium hexafluorophosphate dissolved in a mixed solvent (1:1 in volume ratio) of ethylene carbonate (EC) and diethyl carbonate (DEC). Then, its electrochemical lithium insertion and extraction behavior was measured. The fabrication of the battery was carried out according to the structure and the assembling method of well-known cells.

For the fabricated lithium secondary battery, there was carried out an electrochemical lithium insertion and extraction test under the temperature condition of 25° C. at a current density of 10 mA/g at cutoff potentials of 3.0 V-1.0 V; then, there was observed the voltage variation with voltage plateau at nearly 1.6 V and accompanying the reversible lithium insertion and extraction reaction. This is shown in FIG. 11. The lithium insertion amount of the sample was equivalent to 7.40 per chemical formula of H₂Ti₁₂O₂₅; the initial insertion amount per active material weight was 203 mAh/g; the initial charge and discharge efficiency was 76%, which was higher than 50% of the TiO₂(B); and the capacity retention rate at the initial cycle was 86%, and that after 10 cycles was 76%.

### Comparative Example 2

6.25 g of titanyl sulfate hydrate (TiOSO₄.xH₂O, x is 2 to 5) was added and dissolved in 200 ml of a sulfuric acid aqueous solution containing 7 ml of 95% sulfuric acid, and distilled water was added to finally make 250 ml of a solution. The solution was put in a beaker; a Na₂CO₃ aqueous solution of 240 g/l was dropwise charged at a temperature of 20 to 25° C. under stirring by a magnetic stirrer to thereby obtain a gelatinous precipitation. The dropping speed of the Na₂CO₃ aqueous solution was 10 to 25 ml/h, and the dropping was terminated when the pH became 6.

The resultant was separated by a centrifuge, three times repeatedly washed with distilled water, suspended in 250 ml of distilled water, and put in a round-bottom flask and frozen at the liquid nitrogen temperature. The resultant was dried for one day and night by a freeze-drying method involving vacuumizing by a rotary pump to thereby make a titanium raw material for production of Na₂Ti₃O₇.

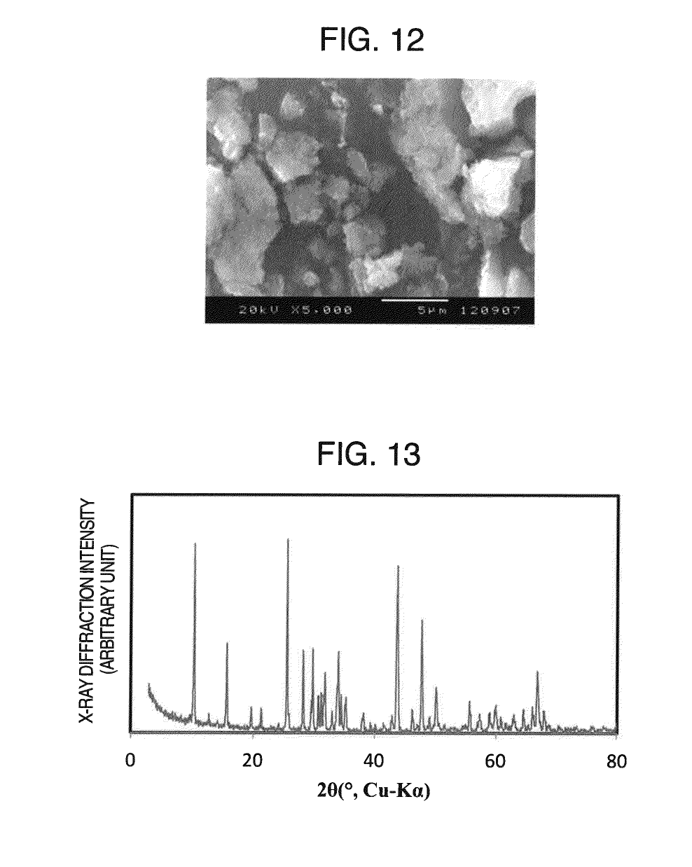

It was found that the obtained titanium raw material was an amorphous titanium oxide with broad peaks at the peak position of anatase-type TiO₂ by an X-ray powder diffractometry. A clear weight loss and endothermic reaction accompanying dehydration were observed at nearly 100° C. by thermogravimetry, revealing that the titanium raw material was a titanium oxide hydrate. It was further found that the titanium raw material powder was a porous body which had a specific surface area of 439 m²/g as measured by the BET specific surface area measurement, an average pore diameter of 3.3 nm, and a pore volume of 0.360 cm³/g. It further became clear by the scanning electron microscope (SEM) observation that particles of 1 to 5 μm which were slightly angular and relatively isotropic aggregated (FIG. 12).

About 1 g of the titanium raw material was suspended in 100 ml of a Na₂CO₃ aqueous solution of 216 g/l, and ultrasonically dispersed for 5 min; and thereafter, the sample was separated from the aqueous solution by filter filtration, and dried at 60° C. for one day and night. The impregnation amount of the porous titanium oxide hydrate with the Na₂CO₃ aqueous solution was previously measured; and the concentration of the Na₂CO₃ aqueous solution was made to be one to make a chemical composition of Na₂Ti₃O₇. The sample was packed in an alumina-made boat, and heated in air at a high temperature by using an electric furnace. The firing temperature was made to be 800° C., and the firing time was made to be 10 hours. Thereafter, the resultant was spontaneously cooled in the electric furnace to thereby obtain Sample 3.

It became clear that Sample 3 thus obtained was a single phase of Na₂Ti₃O₇ with good crystallinity by an X-ray powder diffractometry (FIG. 13). Further, a scanning electron microscope (SEM) observation clarified that particles of 1 to 5 μm in diameter were present and these particles aggregated (FIG. 14).

The Na₂Ti₃O₇ obtained in the above was used as a starting raw material, immersed in a 0.5N hydrochloric acid aqueous solution, and held under the condition of 60° C. for 3 days to thereby carry out a proton exchange treatment. In order to raise the exchange treatment speed, the hydrochloric acid aqueous solution was replaced at every 24 hours. The use amount of the hydrochloric acid aqueous solution per one time was made to be 200 ml with respect to 0.75 g of the Na₂Ti₃O₇ sample. Thereafter, the sample was washed with water, and dried at 60° C. in air for one day and night to thereby obtain a target proton exchange product.

It became clear that the proton exchange product thus obtained was a single phase of H₂Ti₃O₇ by an X-ray powder diffractometry. Further, a scanning electron microscope (SEM) observation clarified that the proton exchange product was relatively isotropic particles holding the shape of Na₂Ti₃O₇ as the starting raw material, or was their aggregate.

Then, the H₂Ti₃O₇ obtained in the above was packed in an alumina crucible, and thereafter subjected to a heat treatment in air at 280° C. for 5 hours to thereby obtain Sample 4. It became clear that Sample 4 thus obtained almost exhibited a diffraction pattern characteristic of H₂Ti₁₂O₂₅ as seen in a past report in X-ray powder diffractometry, but diffraction peaks from traces of H₂Ti₆O₁₃ were observed at portions indicated by the arrows (FIG. 15). Further, a scanning electron microscope (SEM) observation clarified that Sample 4 was relatively isotropic particles which held the shape of Na₂Ti₃O₇ as the starting raw material and the proton exchange product H₂Ti₃O₇, or was their aggregate.

### (A Lithium Secondary Battery)

An electrode was fabricated by using the H₂Ti₁₂O₂₅ (Sample 4) thus obtained as an active material, acetylene black as an electroconductive agent and polytetrafluoroethylene as a binder blended in 5:5:1 in weight ratio. A lithium secondary battery (coin-type cell) as shown in FIG. 9 was fabricated by using the electrode, using a lithium metal as a counter electrode, and using as an electrolyte solution a 1M solution of lithium hexafluorophosphate dissolved in a mixed solvent (1:1 in volume ratio) of ethylene carbonate (EC) and diethyl carbonate (DEC). Then, its electrochemical lithium insertion and extraction behavior was measured. The fabrication of the battery was carried out according to the structure and the assembling method of well-known cells.

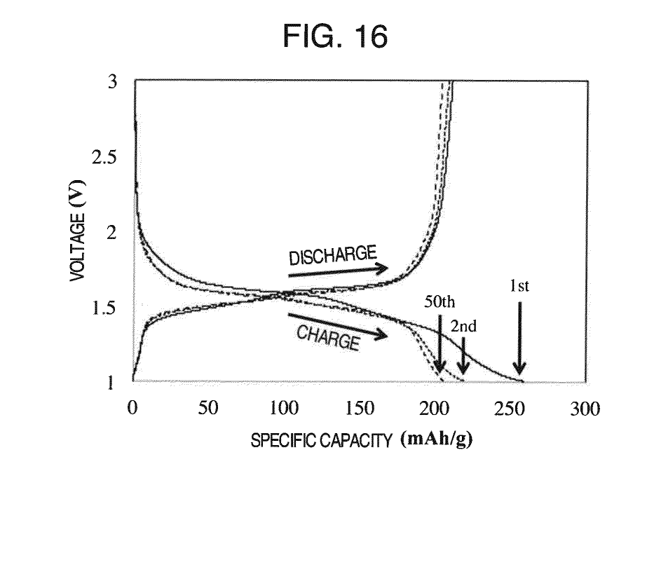

For the fabricated lithium secondary battery, there was carried out an electrochemical lithium insertion and extraction test under the temperature condition of 25° C. at a current density of 10 mA/g at cutoff potentials of 3.0 V-1.0 V; then, there was observed the voltage variation having a voltage plateau at nearly 1.6 V and accompanying the reversible lithium insertion and extraction reaction. This is shown in FIG. 16. The lithium insertion amount of Sample 4 was equivalent to 9.44 per chemical formula of H₂Ti₁₂O₂₅; the initial insertion amount per active material weight was 259 mAh/g, which was nearly equal to that of the TiO₂(B), and was a value higher than 236 mAh/g of the isotropic shape H₂Ti₁₂O₂₅. However, the initial charge and discharge efficiency of Sample 4 was 81%, which was higher than 50% of the TiO₂(B), but was lower than that of the isotropic shape H₂Ti₁₂O₂₅. The capacity retention rate at the initial cycle of Sample 4 was 85%, which was higher than 81% of the TiO₂(B), but was lower than that of the isotropic shape H₂Ti₁₂O₂₅. This is because of the irreversible insertion of lithium due to H₂Ti₆O₁₃ contained partially as traces.

### INDUSTRIAL APPLICABILITY

The present invention provides an alkaline metal titanium oxide and a titanium oxide with novel shape made by assembly of secondary particles comprising assembled primary particles with anisotropic structure. These particles can have an aggregate structure with proper size, can easily be handled, and as required, can easily be disassembled, so the particles are an industrially remarkably advantageous material. The material can be utilized for various applications such as coatings and cosmetics by utilizing such a structure.

Particularly H₂Ti₁₂O₂₅ with form of secondary particles comprising assembled primary particles with anisotropic structure is remarkably high in the practical value as a lithium secondary battery electrode material which has a high capacity, and is excellent in the initial charge and discharge efficiency and the cycle characteristics. The use of this can provide a secondary battery in which a high capacity can be expected and the reversible lithium insertion and extraction reaction is possible, and which can cope with the charge and discharge cycle over a long period.

### REFERENCE SIGNS LIST

1: COIN-TYPE LITHIUM SECONDARY BATTERY
2: NEGATIVE ELECTRODE TERMINAL
3: NEGATIVE ELECTRODE
4: SEPARATOR and ELECTROLYTE SOLUTION
5: INSULATING PACKING
6: POSITIVE ELECTRODE
7: POSITIVE ELECTRODE CAN

1. An alkaline metal titanium oxide secondary particle, comprising assembled primary particles with anisotropic structure.

2. The alkaline metal titanium oxide secondary particle according to claim 1, wherein the secondary particle has a composition formula below:
MxTiyOz (1)
wherein M is one or two alkaline metal elements; x/y is 0.06 to 4.05, and z/y is 1.95 to 4.05; in the case where M is two elements, x denotes a total of the two elements.

3. The alkaline metal titanium oxide secondary particle according to claim 1, exhibiting an X-ray diffraction pattern of MTiO₂, MTi₂O₄, M₂TiO₃, M₂Ti₃O₇, M₂Ti₄O₉, M₂Ti₅O₁₁, M₂Ti₆O₁₃, M₂Ti₈O₁₇, M₂Ti₁₂O₂₅, M₂Ti₁₈O₃₇, M₄TiO₄ or M₄Ti₅O₁₂, wherein M is one or two selected from the group consisting of lithium, sodium, potassium, rubidium and cesium.

4. The alkaline metal titanium oxide secondary particle according to claim 1, forming an aggregate of 0.5 μm or larger and smaller than 500 μm.

5. The alkaline metal titanium oxide secondary particle according to claim 1, having a specific surface area of 0.1 m²/g or larger and smaller than 10 m²/g.

6. A titanium oxide secondary particle, comprising assembled primary particles with anisotropic structure.

7. The titanium oxide secondary particle according to claim 6, having a composition formula below:
HxTiyOz (2)
wherein x/y is 0.06 to 4.05, and z/y is 1.95 to 4.05.

8. The titanium oxide secondary particle according to claim 6, exhibiting an X-ray diffraction pattern of HTiO₂, HTi₂O₄, H₂TiO₃, H₂Ti₃O₇, H₂Ti₄O₉, H₂Ti₅O₁₁, H₂Ti₆O₁₃, H₂Ti₈O₁₇, H₂Ti₁₂O₂₅, H₂Ti₁₈O₃₇, H₄TiO₄ or H₄Ti₅O₁₂.

9. The titanium oxide secondary particle according to claim 8, exhibiting an X-ray diffraction pattern of H₂Ti₁₂O₂₅.

10. The titanium oxide secondary particle according to claim 6, wherein the secondary particles form an aggregate of 0.5 μm or larger and smaller than 500 μm.

11. The titanium oxide secondary particle according to claim 6, having a specific surface area of 0.1 m²/g or larger and smaller than 10 m²/g.

12. An electrode active material, comprising an alkaline metal titanium oxide secondary particle or a titanium oxide secondary particle according to claim 1.

13. A power storage device, using an electrode active material according to claim 12.

14. An electrode active material, comprising an alkaline metal titanium oxide secondary particle or a titanium oxide secondary particle according to claim 6.

15. A power storage device, using an electrode active material according to claim 14.
